(19) United States
(12) Patent Application Publication
(10) Pub. No.: US 2004/0030746 A1
(43) Pub. Date: Feb. 12, 2004

(54) Hierarchical client detection in a wireless portal server

(76) Inventors: Sathyanarayanan Kavacheri, Sunnyvale, CA (US); Luu Tran, Santa Clara, CA (US)

Correspondence Address: WAGNER, MURABITO & HAO LLP, Third Floor, Two North Market Street, San Jose, CA, 95113, US

(21) Appl. No.: 10/622,152

(22) Filed: Jul. 16, 2003

Related U.S. Application Data
(63) Continuation-in-part of application No. 09/929,477, filed on Aug. 13, 2001.

(51) Int. Cl. G06F 15/16

(52) U.S. Cl. 709/203; 709/223

(57) ABSTRACT

A wireless portal system having a wireless portal server with a hierarchical client detection mechanism. The hierarchical client detection mechanism includes logic for identifying client wireless devices connecting to the wireless portal server by using a hierarchical search path of predefined client profile information stored in the wireless portal server. In searching for client profile information, the client detection logic first looks for an exact match for a connecting device and if that fails, attempts to find an approximate match of the predefined profile information for the connecting device. A failure in finding either an exact or approximate match results in the client detection logic looking for a match within the profile information of a class of devices similar to the connecting client wireless device. In one embodiment of the invention, the client detection mechanism is capable of being extended by the client to add-on client information characteristics which are not already pre-stored in the wireless server. In this way, the client detection logic of the invention is extensible to recognize new devices without requiring software version updates or complex programming tasks.

### CROSS REFERENCE TO RELATED APPLICATION

This is a continuation-in-part to Luu et al., commonly assigned U.S. patent application Ser. No. 09/929,477, filed Aug. 13, 2001, with attorney Docket No. SUN-P6087/ACM/DKA., entitled “Extensible Client Aware Detection in a Wireless Portal System” by Luu D. Tran et. al. To the extent not repeated herein, the contents of Luu D. Tran et al., are incorporated herein by reference.

This Application is related to the following commonly owned co-pending U.S. Patent Applications: “System and Method for Client Aware Request Dispatching in a Portal Server, ”by Ziebold et al., filed on ______, Ser. No. ______, Attorney Docket No. SUN-P030066; “Hierarchical Client Aggregation in a Wireless Portal Server, ”by Ziebold et al., filed on ______, Ser. No. ______, Attorney Docket No. SUN-P030068; “Extensible Customizable Structured and Managed Client Data Storage,” by Kavacheri et al., filed on ______, Ser. No. ______, Attorney Docket No. SUN-P030090; the contents of which are incorporated herein by reference.

1. Field of the Invention

The present claimed invention relates generally to the field of wireless communication systems. More particularly, the present claimed invention relates to hierarchical client detection in a client independent wireless environment.

2. Background Art

The Internet has become the dominant vehicle for data communications. And with the growth of Internet usage has come a corresponding growth in the usage of Internet devices, wireless devices and services.

The growing base of Internet users has become accustomed to readily accessing Internet-based services such as electronic mail “e-mail”, calendar or content at any time from any location. These services, however, have traditionally been accessible primarily through stationary desktop computers. However, demand is now building for easy access to these and other communication services for mobile devices.

As the demand for mobile and wireless devices increases, enterprises must rollout new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional browser desktop services to these new wireless markets.

With the growth of the wireless market comes a corresponding growth in wireless business opportunities which in today's ever-growing markets means, there is a plethora of services available to customers of the people that use these services. Many wireless service providers are now looking to increase core services by extending services such as e-mail, short messaging service notification, and other links to IP-based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and need to provide content suitable for these devices without incurring substantial cost overhead.

The growth in wireless devices also means that traditional computer users who were tied to their desktop computers may now be mobile and would require remote access to network applications and services such as email. The mobility of wireless users presents a host of challenges to service providers who may have to provide traditional service to these new wireless devices. One such service is provided by Sun Microsystems, Inc., through its SUN ONE™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. The growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless clients running similar applications or portals. The environment depicted in FIG. 1 includes wireless devices such as a WAP phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community based web pages or sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Explorer Browser and the Netscape Communicator Browser. These browsers are both Hyper Text Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers which appropriately adapt to these wireless devices with different display screen requirements in order to take advantage of the numerous content on the Internet. The availability of these new micro-browsers and other capabilities of the wireless client means that service providers do not have to create different sets of content for different wireless devices even if the devices are dissimilar.

The support of primarily only two major types of browsers is a drawback because it does not allow the wireless server to identify and recognize a myriad of micro browsers such as those used by a host of wireless phones and other handheld devices other than the two major types. This restricts the number of wireless client devices which may be connected to the server.

In the prior art wireless environment depicted in FIG. 1, clients requesting services to the wireless environment are identified by the server by one of two ways. The first is by way of predefined, pre-configured device types which are stored in the server and enable the server to identify clients trying to connect to it. The second method of detection is by way of a complex tool-kit which is typically sold with the wireless clients. In the case of the tool-kit approach, the end-user has the burden of programming the client in order for the wireless server to identify the client during a connection session to the server.

Either one of these prior art detection schemes has drawbacks. In the first detection scheme, the wireless server is unable to identify device types which are not pre-defined and stored in the server. An entire software upgrade is required to recognize new client types. And in the second scheme, the end-user requires technical software programming expertise to be able to program the tool-kit to enable detection and use of the wireless server resources.

Another drawback of the prior art system as shown in FIG. 1, is that identifying a wireless client with the right capabilities, the type of markup language the client uses, the locale and the general operating environment of the wireless client is tedious and cumbersome. The server in FIG. 1 does not either have the capabilities of storing all the requisite information required for a variety of clients or stores just enough information to support clients that operate with the default browser supported by the server.

Another drawback of the prior art system as shown in FIG. 1, is that most of the servers are designed to identify clients using the least common characteristics of known clients. For example, a server which is designed to recognize wireless phones will have as the least common identifier the phone characteristics common to all the identifiable phones which will be used to identify the service request to the wireless environment. Thus, if two wireless phones exist of the same manufacturer, but with two dissimilar screen requirements (e.g., 4 line text display vs. 8 line text display), then the server will be designed to support wireless phones by that manufacturer as requiring only 4 line text display (least common characteristic).

The discrepancies between display information on the two phones in this example becomes very pronounced if one considers the fact that the phone requiring an 8 line text display loses 50% of its display capabilities. Thus, the client is unable to take advantage of the full richness such as the look and feel features of the client interface with the end-user, the scripting behavior of the interface, etc.

A further drawback of the wireless server of the prior art is that most of the servers are designed to identify wireless clients using HTML as the default identifier. Thus, a client running any other Internet language will not be identified and therefore denied services, or given incompatible content.

### SUMMARY OF INVENTION

Accordingly, to take advantage of the myriad of applications and the numerous wireless clients being developed, a wireless server with extensibility capabilities to allow wireless clients to be dynamically configured and identified by the wireless portal server is needed. A need exists for “out-of-the-box” wireless system solutions to allow a wide range of end-users to connect to the wireless environment without unduly tasking the end-user's technical abilities. A need further exists for an improved and less costly device independent system which improves efficiency and identification of various wireless clients without losing the embedded features designed for these devices.

The present invention is directed to a system and a method for hierarchically identifying wireless clients in a client independent wireless system. Embodiments of the present invention are capable of handling both voice and data transmission over an Internet protocol local access network within wireless systems without losing inherent characteristics of the client when it connects to a wireless server within the wireless system to request services. In general, embodiments of the present invention vary the degree of identifying wireless clients connecting to a wireless portal server using a variety of search mechanisms to implement a hierarchical search of profile information stored in the wireless server to retrieve detailed client information to allow the wireless client to automatically connect to the wireless server.

Embodiments of the invention include pluggable client detection modules which provide automatic and extensible client identification using characteristics of the client as unique identifiers by the wireless portal server to provide services. The client characteristics may or may not be known to the wireless portal server at the time a client attempts to connect to the server. An Application Program Interface (API) is used which can assist newly created “out-of-the-box” detection modules to add detection support to the server.

Embodiments of the present invention further include client extensible logic which allows the wireless client devices to dynamically add additional characteristics to any defaults that might be stored in the wireless portal server. These characteristics enable the server to identify the client as the client attempts to connect to the server. In this way, the client detection logic of the invention is extensible to recognize new device classes without requiring software version updates or complex programming tasks. In one embodiment, an API can be used to collect extensible data sets that include custom parameters for recognizing a particular client class, such as defined header information of the client's browser, the time of day the client requests are received and the client's bandwidth.

In one embodiment of the present invention, the hierarchical client detection system is able to retrieve client profile information in a manner to allow clients of the same or similar configuration or class to access data unique to a particular client's capabilities. This allows the present invention to provide client access information requested by a particular client to the wireless portal server based on characteristics unique to the particular client.

Embodiments of the present invention further include a list configurable HTTP headers, for example, for client devices connecting to the wireless portal server. The list of HTTP headers to parse is configurable. A user can add any valid HTTP header to the list of headers to be used for client detection. A user agent information is also parsed to identify wireless client type information to enable the wireless portal server to provide the appropriate services to identified clients connected to the system.

In one embodiment, the hierarchical client detection system identifies the type or class of the wireless client devices and stores this information into a clienttype profile repository database. The clienttype profile repository database information can be then used by the hierarchical client detection system to automatically access the most pertinent client device configuration data for the client devices using an intelligent hierarchical data look-up system. Client identification or class information can be used in automatically constructing a hierarchical search path to the most pertinent access verification information for each client device.

In one embodiment, the client detection module first looks for exact matches for a connecting device to the wireless portal server and if a match is not found, the client detection module switches to approximate matches. If an approximate is not found, the client detection module then switches to matching the device with a class of devices and depending on the configuration, either creates a new profile in the wireless portal server for the connecting device based on a particular class of matching devices and stores the profile in a persistent store or keeps a reference in memory. Keeping the created profile in memory enables subsequent queries by the device to the wireless portal server to get an exact match.

In one embodiment of the present invention, the match for the devices also supports the Open Mobile Alliance standard user agent profile specifications, so that the type of match is based on either looking at the incoming request only or using the profiles provided by a vendor or a combination of both. The matching logic is also optimized to store the results of the partial matches so subsequent queries are faster.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless portal system of the present invention;

FIG. 3 is a block diagram of an exemplary internal architecture of the wireless portal server of FIG. 2;

FIG. 4 is a block diagram of an embodiment of the hierarchical client detection system of the present invention;

FIG. 5 is a diagram illustrating a hierarchical search path to identify client access information in the wireless portal server of one embodiment of the present invention; and

FIG. 6 is a computer implemented flow diagram of an embodiment of the hierarchical client detection system of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The invention is directed to a system, an architecture, subsystem and method to manage hierarchical wireless client detection in a client independent wireless environment in a way superior to the prior art. In accordance with an aspect of the invention, a wireless portal server provides wireless client device extensibility which enables non predefined devices in the wireless server to be identified by the wireless portal server.

In the following detailed description of the present invention, a system and method for a wireless Internet protocol based communication system is described. Numerous specific details are not set forth in order to provide a thorough understanding of the present invention. However, it will be recognized by one skilled in the art that the present invention may be practiced without these specific details or with equivalents thereof.

Generally, an aspect of the invention encompasses providing an integrated wireless Internet portal server which provides a wide range of voice, data, video and other services to wireless client devices which may connect to the wireless environment to be serviced alongside predefined wireless clients.

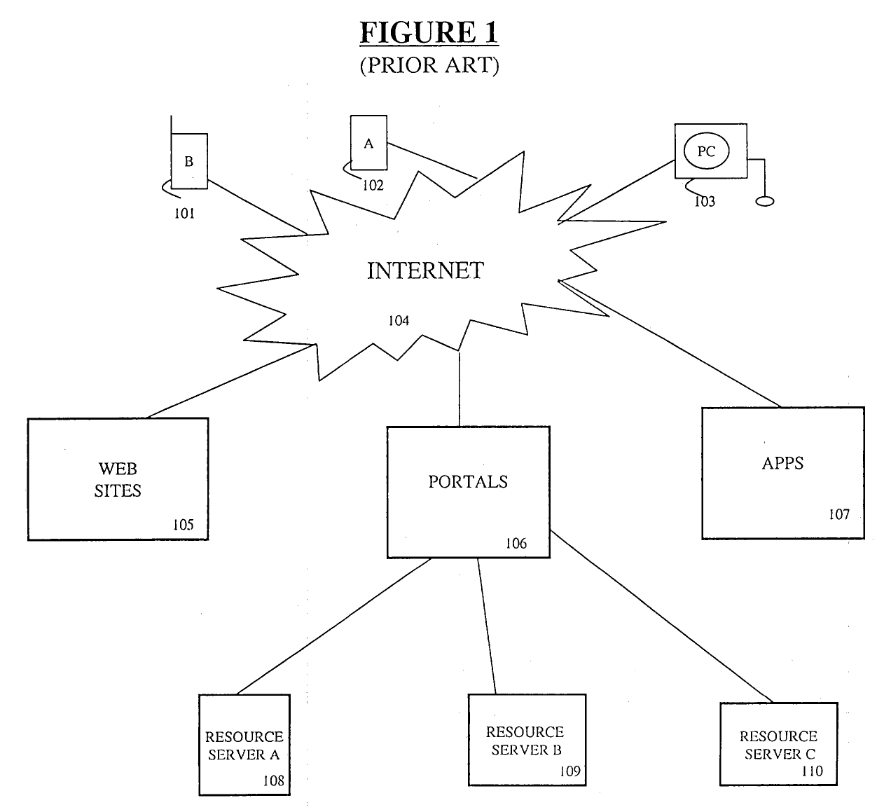

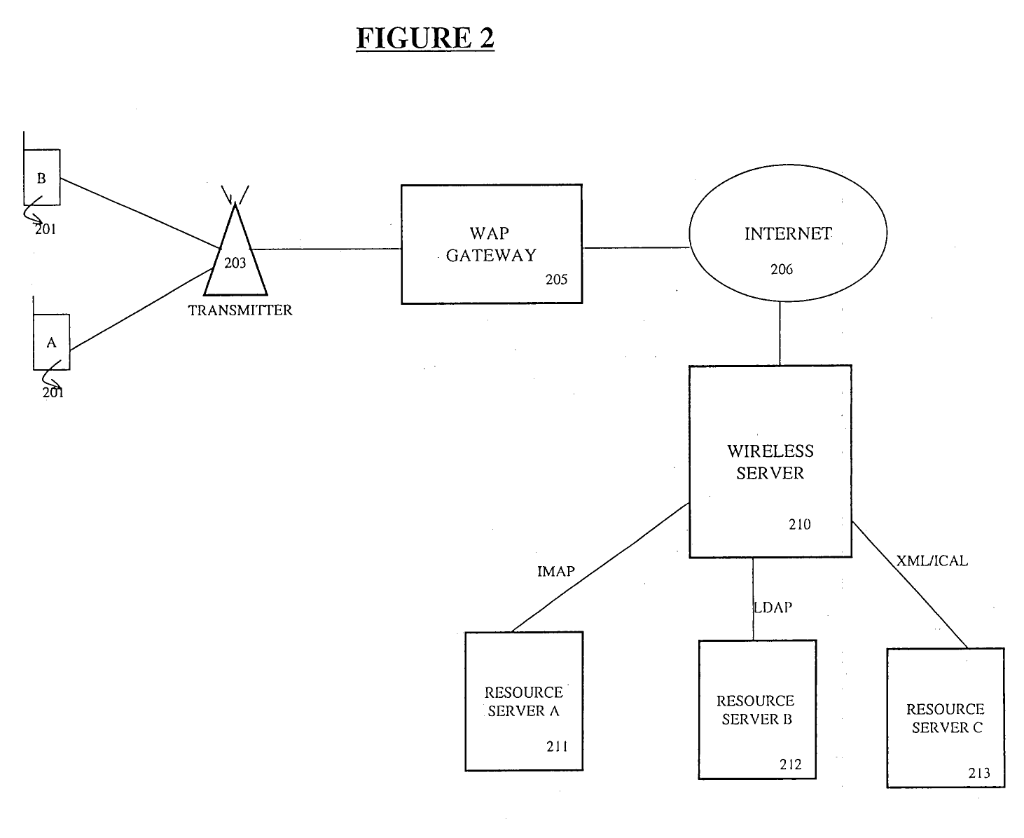

FIG. 2 depicts an embodiment of the wireless device independent based environment of the present invention. The wireless environment depicted in FIG. 2 comprises a wireless application protocol (WAP) based phone 201, a WAP transmission infrastructure 203, a WAP gateway 205, the Internet 206 and a wireless portal server 210. In a Global Switch Mobile network for instance, when the phone transmission is received by the mobile switching center, it realizes it is packet data and sends it to the proper channel to be processed. The WAP gateway 205 typically resides on the Local Area Network (LAN) within a telecom carriers premises. It is not generally a part of the wireless server. The WAP gateway 205 is responsible for connecting the Wireless Markup Language/HTTP content and protocol into a bundled compressed, encoded, encrypted version of WML over WAP.

Conversely, the WAP gateway 205 also performs the translation of WAP commands into HTTP requests which can be sent over the public Internet. The WAP gateway 205 can also store user's bookmarks, two of which could point to the wireless portal server's messaging and other resource services for instance. The wireless portal server 210 communicates WML over HTTP on the front-end and communicates in native protocol of the target server on the back-end.

The wireless portal server 210 communicates to these back-end resource servers using the backend server's native protocol. For example, the wireless portal server 210 may communicate to resource server A 211 which may be a messaging server using Internet Message Access Protocol (IMAP). A Lightweight Directory Access Protocol (LDAP) is used for all communications to and from the resource server B 212. And an extensible markup language (XML) protocol may be used to communicate with resource server C.

Although the wireless portal server depicted in FIG. 2 is capable of communicating in these native protocols shown in FIG. 2, the wireless server protocol's handling capability can be extended to support other protocols. The wireless server implements the Wireless Markup Language (WML) interface and generates the corresponding WML content based on what it receives from the back-end server.

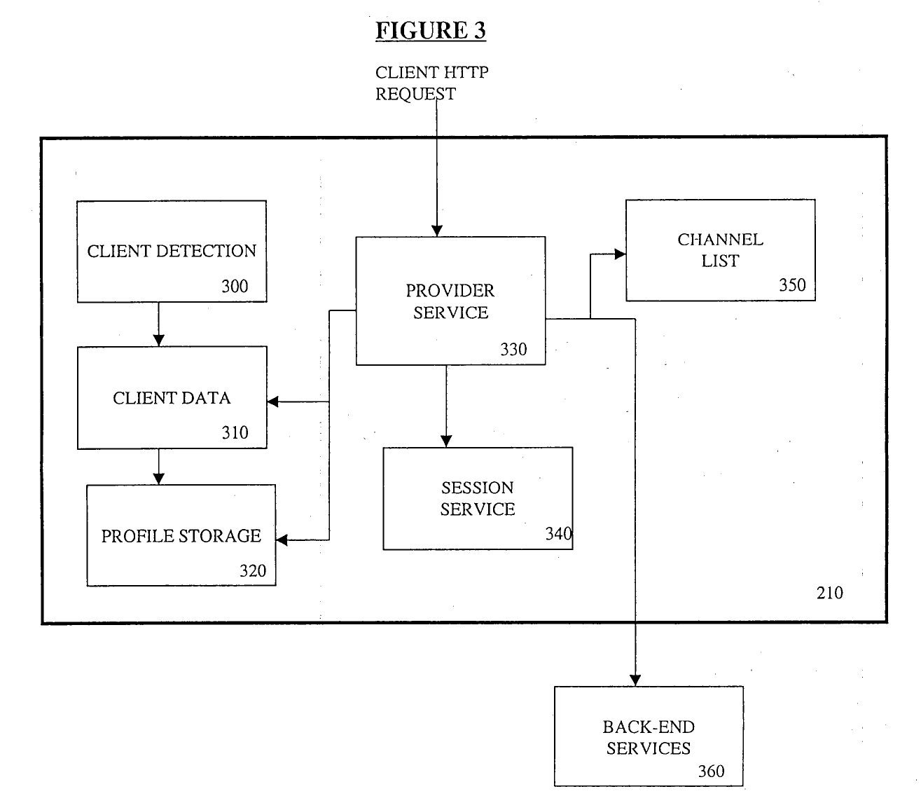

FIG. 3 is a block diagram illustration of one embodiment of the wireless system of the present invention. The wireless system shown in FIG. 3 includes a wireless portal server 210 (WPS). The WPS 210 includes hierarchical client detection module (HCDM) 300, client data (CD) module 310 which couples to CDM 300, profile service (PS) module 320 which couples to CD 310, session service (SS) module 340 and channel list module (CLM) 350. WPS 210 may include other modules which have not been disclosed here in order not to confuse the teachings of the present invention.

The wireless portal server 210 shown in FIG. 3 is flexible, scalable, extensible and capable of supporting a rich evolving range of networks such as Global system for mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the handheld device markup language (HDML) and the hypertext markup language (HTML). The server 210 is capable of providing support for multiple devices and is easily adaptable and extensible to additional devices and markup languages.

HCDM 300 receives client service request to WPS 210 via a client detection software API. The HCDM 300 determines the clients device characteristic such as content-type, template directory, etc., the HCDM 300 does not assume a client request to only emanate from HTML based devices and is therefore capable of identifying a host of other markup languages used by a number of wireless client devices. In one embodiment of the present invention, the HCDM 300 is configurable to handle other headers other than HTTP headers. The HCDM 300 can also create new client data from the client's request.

The HCDM 300 stores device profiles with hundreds of client type definitions, each with over a hundred properties defined to enable the HCDM 300 to map client file requests that are used to uniquely identify and hierarchically retrieved from the profile repository in a client specific detection manner. In one embodiment of the present invention the client profile information is World Wide Web Consortium (W3C) standards compliant. The HCDM 300 performs specific client information retrieval as defined with client specific parameters in the client header request at the time the client device attempts to connect to the wireless portal server 210. These parameters may include the client's device type, the client's display capabilities, memory capacity, bandwidth capabilities, the client's markup language, etc.

The client type information gathered by the HCDM 300 in the present invention may also include the client's browser type, version number and underlying Operating System supporting the browser. The client type information may further include the time of the day the client is allowed to receive certain services by the content provider (e.g., real time stock quotes, etc.), client's location, etc. All of this information can be used by the HCDM 300 to automatically detect the client type.

Client data extracted by HCDM 300 is passed to CD 310 which stores client data objects of various properties of the client, such as user-agent matching pattern, acceptable response content-type, cookie support status, etc. Unlike the prior art, CD 310 relies on other characteristics of a client's request information for storage rather than assuming that any client request information represented a generic HTML device. Furthermore, in the present invention, CD 310 is readily extensible to enable additional attributes of a client device connecting to WPS 210 to be dynamically added as needed.

SS module 340 of FIG. 3 stores transient information pertaining to a user's active session with the client device when the client initiates a service request to the server. A new session property is defined to store a client type identifier after the client has been detected by the wireless portal server 210.

HCDM 300 further performs automatic client detection based on header information contained in the client's browser, (e.g., name of browser, version, operating system supported by the browser, hardware descriptions, etc.), the time of day the client request is received and the bandwidth of the client's communication. These and other factors are aggregated together and considered by the HCDM 300 during its automatic detection processes.

Importantly, the HCDM 300 requires data modules for performing individual client type detection. These data modules are extensible so that new detection can be added for header type information, bandwidth information, time of day information, which all can be used to recognize a particular new client type.

Provider service 330 uses the client data 310 to access a hierarchical search path in the server 210 to retrieve appropriate device specific templates. In the present invention, client data objects are extensible to allow additional properties to be added as needed for use by provider service 330. Provider service 330 also uses a profile software API to store and retrieve provider specific properties in profile storage 320.

Channel List 350 is coupled to provider service 330 to provide methods to store and retrieve multiple lists of selectable and available channels for the clients. In one embodiment of the present invention, channel list 350 provides separate available and selectable lists for each client in a client aware manner. This allows users of these clients to independently configure what channels are displayed on their separate devices.

The present invention provides methods to display specific content in the form of channels of the channel list 350. For example, on an HTML device, these channels appear as table cells and on WML devices the channels appear as links to WML cards containing the contents of the channel.

Referring still to FIG. 3, profile storage 320 is coupled to client data 310 and provider 330 to provide selection and availability methods to Provider 330 using the client-type information stored in the client data 310. The profile storage 320 stores persistent client profile data to represent the variety of clients supported by the wireless portal server 210. The client profile information is stored in internal or external data repositories that may be accessed by the client detection module 300. In one embodiment of the present invention, the client profile information stored in the external data repositories are customizable by a system administrator to add new client profile data as new clients connect to the wireless portal server 210.

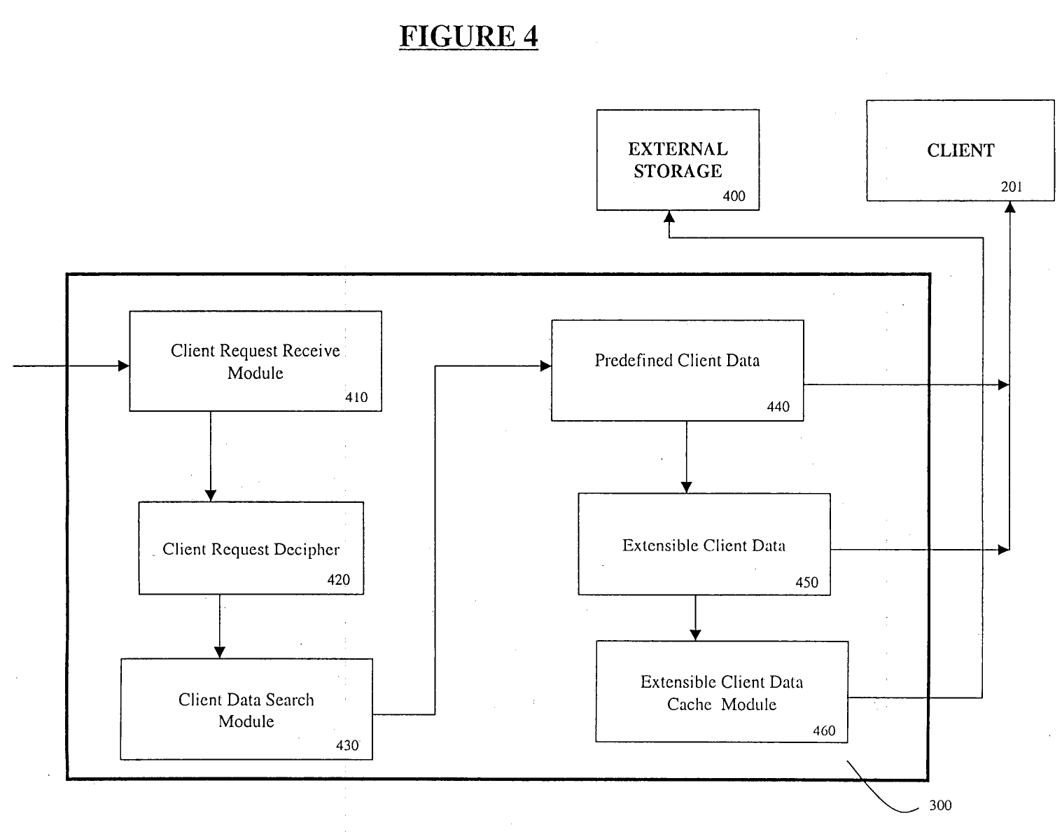

Referring now to FIG. 4, a block diagram illustration of one embodiment of the hierarchical client detection module (CDM) 300 is shown. CDM 300 comprises a client request receiving logic (CRRL) unit 410, a client request deciphering logic unit (CDL) 420, client data search unit 430, predefined client data logic unit (PCD) 440, extensible client data unit (ECD) 450 and extensible client data cache unit 460.

All client service requests made to the WPS 210 from clients connecting to the wireless network are passed to CRRL 410. When a client initiates a service request, the request is forwarded to CRRL 410. Each client service request includes header information from which CRRL 410 is able to extract the necessary client specific characteristics to process the request. When CRRL 410 receives the client's initial request, it parses the HTTP header in the client's request to get the User Agent (UA) information. The parsed information is then passed on to the CDL 420. CRRL 410 may also use other headers apart form the user-agent headers to extract the client-type information. In one embodiment of the present invention, a list of HTTP headers to parse is configurable. The user can add any valid HTTP header to the list of headers to be used for client detection. For example, the user may configure the CRRL 410 to look for a header called “Accept” and if it contains the text “Text/xhtml” to map it to an XHTML device. This will be written as follows;

<RULE>

<Header> ACCEPT </Header>
<look for> text/xhtml </look for>
<map> XHTML </MAP

<RULE>

CDL 420 couples to CRRL 410 to process the UA information received from the client request HTTP headers. Embedded in each UA is information which specifies the client device type. If the UA indicates a device type which matches known client types (predefined clients), CDL 420 executes a call to the client search unit 430 and attempts to find a match for user agents. If a match is determined by search unit 430, the client is connected to the server 210 and provided with the service being requested. For example, if the UA indicates that the device is a WAP phone, the appropriate client-type identifier is stored in session for the client.

Based on the stored client-type identifier, the server knows which method to invoke to provided the requested service. In addition to the UA, CRD 420 can look at other headers of the client request, such as the time of day (e.g., time of day the client can have access to certain services in the wireless environment as defined by the service provider), the user making the request and other information that may be gathered from the client's environment in determining what services to provide the client in response to the client's request.

The client search unit 430 performs a hierarchical search of the profile storage unit 320 to look for an exact match of the device. If an exact match is not found based on the header information contained in the client's request, the client search unit 430 switches to look-up approximate matches for the client. If an approximate match is not found, the client search unit 430 switches to look-up matching in a class of predefined device information. Depending on the configuration, it either creates a new profile in the portal server 210 of the device based on the particular class and stores the new profile information in the persistent storage unit 400 or keeps a reference in system memory for subsequent queries by the client to hit an exact match. In one embodiment of the present invention, the order of matches may be configured by a system administrator of the portal server.

The search unit 430 also provides a ruleset stored in the wireless portal server and retrieved by the client detection data API. In one embodiment of the present invention, the search ruleset enables the client detection module 300 determine which search rules to apply in hierarchically retrieving the client-type profile information to be applied to a requesting client device. An exemplary ruleset used by the search unit 430 is as follows:

<SearchRule>

<HeaderAttribute>user-agent</HeaderAttribute>

</SearchRule>

If the search unit 430 is unable to find an exact match for the client-type of the requesting client device, the search unit 430 applies the following ruleset to create a new client instance. This client data is stored in an external repository. In addition to storing the new client data in the external repository, the new client instance is added to a client type manager. The client instance data stored in the external repository may be customized by a system administrator. An exemplary ruleset for the new client instance is as follows:

<Search Rule>

<Header>user-agent</Header>

<Search>Blazer</Search>

<Map>CHtml</Map>

</SearchRule>

<SearchRule>

<Header>user-agent</Header>

<Search>JPHONE</Search>

<Map>JHtml</Map>

</SearchRule>

The new client instance is then populated with attributes from the request header based on the following exemplary ruleset:

<UAHeaderMapSet>

<DimensionDelimiter>, </DimensionDelimiter>

<Header>user-agent</Header>

<UAProperty>RecipientAppAgent</UAProperty></UAHeaderMap Set>

When a new client instance is created, a call is executed to ECD 440 to extend the current data objects stored in the server, thereby effectively creating a subclass and overriding certain predefined methods in the server. This functionality is important since many wireless devices have unique interfaces and do not follow a common implementation standard, it is critical for a WML generation engine in WPS 210 to be flexible and extensible to add these new devices. Extensibility in the present invention is achieved by implementing API level additions by the content server provider, who provide services to the wireless clients, to add environmental characteristics to uniquely identify and distinguish a class of clients from others. The extensible API could also be programmed by a system developer from run-time information gathered from the client.

Since WPS 210 knows about the differences between various wireless devices, e.g., differences between WAP phones or differences between phone and Palm browsers, etc. CRD 420 does not need to know the differences between devices. It generally only needs to present the client characteristics provided by the client to be processed in WPS 210.

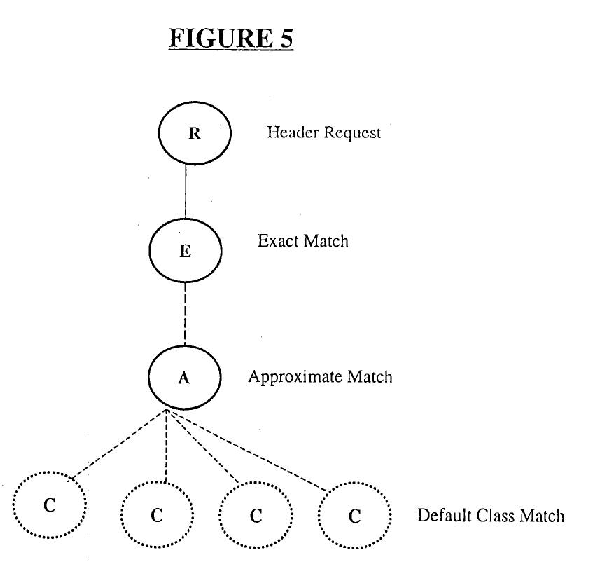

FIG. 5 is an exemplary illustration of a hierarchical client-type information retrieval by the client detection module 300 of one embodiment of the present invention. As shown in FIG. 5, upon receiving the client device request header “R”, the client detection module 300 performs a recursive hierarchical search of the profile repository to determine if there is a corresponding exact match to the header request in the profile repository at the first stage “E.” If the client detection module 300 does not find an exact match, it proceeds to conduct an approximate information match to determine whether keywords or strings of data in the header request have a corresponding approximate match to the data in the profile repository.

If the approximate matching does not yield any result, the client detection module 300 proceeds to stage “C” where the client detection module 300 attempts to find matches to the header request from a repository for a class of devices in the profile repository. An exemplary code to perform the hierarchical search of the profile repository is as follows:

{

```
/**
*Implementation for the Interface
*/
public String getClientType(HttpServletRequest){
    Client Ct = getClient(reques);
    Return ct.getClientType( );
}
protected Client getClient(HttpServletRequest){
  //first try an exact match
Map raMap = mgr.getRecipientAgentMap( );
```

Client ct=(Client) raMap.get(user-agent-string);
//if no Client found —do an approximate search
for (all keys in the raMap){

if (key contains searchString)
ct=(Client)raMap.get(key);

}
//then do the other http headers search.
//and add the new cClient to the Manager-if newClient
created mngr.putClient (user-agent-string,

newClientMap);

return ct;
}

}

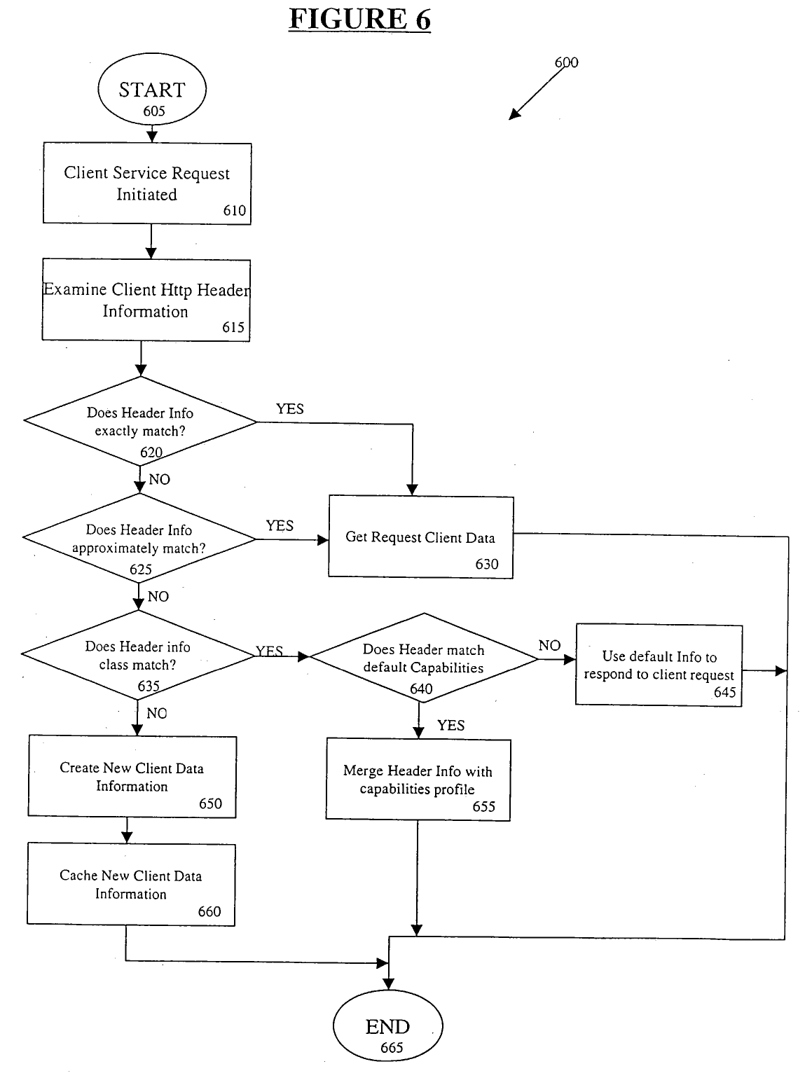

Referring now to FIG. 6, a computer implemented flow diagram of one embodiment of the hierarchical client detection scheme of the present invention is shown. This flow may be implemented by a server system. A client initiates service request to initiate the detection scheme at step 610.

At step 615, the client detection module examines the HTTP header from the client request using the client data API to access the client data objects to find a suitable match in the profile repository.

At step 620, if the client detection module 300 determines whether the header request information provided by the client device exactly client-type information stored in the profile repository. If the client detection module 300 finds an exact match for the incoming request header in the profile repository, the requesting client device information is retrieved at step 630. In the present invention, client-type defines a logic group of clients uniquely identified by an extensible list of properties. Two devices that are of the same client-type can be treated as identical as far as how the server should respond to their requests.

If, on the other hand, an exact profile match is not found in the profile repository for the requesting client device, the client detection module 300 searches for approximate matches by searching for request strings that approximately match that of the requesting header information provided by the client device at step 625. For example, when a client device presents a requesting header request containing the HTTP string “jphone”, “jhtml”, etc., the client detection module 300 will search for a predefined string of “jphone” in the external repository and if the string “jhtml” is not found, will partially match the predefined information having “jphone” with the incoming request. If there is an approximate match of repository profile information with the incoming request for the particular client device, the appropriate data is retrieved at step 630.

At step 635, if there is an approximate client match, the client detection module 300 performs a class search to match the incoming request to define class profile information for devices similar to the requesting client device. At step 640, the client detection module 300 determines whether the retrieved class header information matches predefined default capabilities for devices of similar configuration that connect to the wireless portal server 210.

In determining whether the client device matches the predefined default capabilities, the client detection module 300 determines if the client supports Composite Capabilities/Preferences Profile or UserAgentProfile by looking for the HTTP headers, such as x-wap-profile and x-wap-profile-diff. Composite Capabilities/Preferences Profile is a description of device capabilities and user preferences that can be used to guide the adaptation of content presented to that particular device. If these headers are not found, then a default based client lookup is performed at step 645. If the capabilities headers are found, the client detection module 300 performs a merger of the capabilities profile specified by the headers and returns a map of the client data at step 655.

If the client detection module 300 does not find a class match to the requesting header information, a new client is created at step 650. In one embodiment of the present invention, the newly created client object information will have the base profile as a sorted set to store all the parent profiles it inherited from and stored in the external repository. The client object stored in the external repository can be customized by a system administrator.

The new client object created is stored in a transient internal repository at step 660 to allow the new client faster subsequent queries to the cached profiles. In one embodiment of the present invention, the cached profiles are kept synchronized with the profile information stored in the external repository through an event notification scheme in order to keep the cached profile data from going stale.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A wireless network environment, comprising:
a plurality of classes of wireless clients, each comprising unique identifiers and attributes independent of other classes of wireless clients within the wireless network environment; and
a wireless client independent portal server coupled to communicate with said plurality of classes of wireless clients to provide a series of services available on said portal server, said plurality of classes of wireless clients issuing service requests to the portal server via established communication links and protocols within the network; and
wherein one of said services comprise a hierarchical client detection service using extensible predefined parameters.

2. The wireless network environment of claim 1, wherein said hierarchical client detection service comprises client detection logic for hierarchically detecting client specific attributes from service requests issued to said portal server from a wireless client device within any of the plurality of classes of wireless clients.

3. The wireless network environment of claim 2, wherein said portal server further includes a wireless client data storage unit coupled to said client detection logic to store client data objects which uniquely define each client within said plurality of classes of wireless clients.

4. The wireless network environment of claim 2, wherein said client detection logic further detects client specific attributes of a wireless client by hierarchically searching said client data storage unit to extract profile information from the portal server by examining a hypertext transport protocol header coming from the client's request.

5. The wireless network environment of claim 3, wherein said client detection logic comprises client data distinguishing logic for distinguishing between predefined client information pertaining to a client within any of said plurality of classes of wireless clients stored in said wireless client data storage unit and client data information which is dynamically extracted by said client detection logic from incoming client requests to the portal server.

6. The wireless network environment of claim 4, wherein said client detection logic is extensible to dynamically gather client specific information as said client issues service requests to said portal server and when said client specific information is not available in said wireless client data storage unit.

7. The wireless network environment of claim 6, wherein said client detection logic extracts client specific attributes from a user-agent Hyper Text Transport Protocol header from a client request to the portal server.

8. The wireless network environment of claim 7, wherein said client detection logic extracts client specific attributes from headers other than said user-agent Hyper Text Transport Protocol header.

9. The wireless network environment of claim 6, wherein said wireless client data storage unit comprises an internal client data storage unit for storing new client instance transient data that is absent from the portal server for wireless client devices connecting to said portal server.

10. The wireless network environment of claim 9, wherein said wireless client data storage unit further comprises an external client data storage unit for storing persistent data comprising extensible predefined data.

11. A wireless portal server for handling a plurality of wireless service requests from a plurality of wireless clients each having unique identifying attributes, said wireless portal server comprising:
a wireless extensible hierarchical client detector;
a wireless client data storage coupled to said wireless extensible hierarchical client detector; and
a wireless client data service coupled to said wireless extensible hierarchical client detector.

12. The wireless portal server of claim 11, wherein said wireless extensible hierarchical client detector extracts client specific data to identify wireless clients that request services from said wireless portal server by hierarchically searching said wireless client data storage to extract data that exactly matches said client specific data present in a service request header of a wireless client.

13. The wireless portal server of claim 12, wherein said wireless extensible hierarchical client detector extracts said client specific data to identify wireless clients that request service from said wireless portal server by hierarchically searching said wireless client data storage to extract data that partially matches said client specific data present in a service request header of a wireless client.

14. The wireless portal server of claim 13, wherein said wireless extensible hierarchical client detector further extracts said client specific data to identify wireless clients that request service from said wireless portal server by hierarchically searching said wireless client data storage to extract data that matches predefined classes of wireless clients similar to said client specific data in a service request header of a wireless client.

15. The wireless portal server of claim 11, wherein the wireless extensible hierarchical client detector comprises logic to differentiate predefined data pertaining to a first wireless client of a particular class of wireless clients stored in the wireless portal server from client specific data dynamically extracted as a second wireless client connects to said wireless portal server.

16. The wireless portal server of claim 15, wherein the wireless client data storage comprises an external client data storage that stores persistent client predefined data objects for a known class of wireless clients which connect to the wireless portal server.

17. The wireless portal server of claim 16, wherein the wireless client data storage further comprises an internal client data storage that stores transient data objects dynamically provided by a wireless client connecting to said wireless portal server without any predefined data objects.

18. The wireless portal server of claim 17, wherein the wireless extensible hierarchical client detector comprises client request deciphering logic for parsing client service request headers to determine whether data pertaining to a specific client requesting service from the wireless portal server is already available in the wireless server.

19. The wireless portal server of claim 18, wherein the hierarchical client detector further comprises client data extensible logic for dynamically extracting “client-type” information which is absent from the wireless portal server from the client request headers and storing said extracted data in said internal client data storage unit.

20. The wireless portal server of claim 19, wherein said “client-type” information defines a logical class of clients uniquely identified by an extensible list of properties common to the class.

21. The wireless portal server of claim 20, wherein said wireless extensible hierarchical client detector further comprises client data search logic for hierarchically searching to match said predefined data objects in the wireless client storage unit to said client request headers.

22. A method of detecting wireless clients within a wireless network connecting to a wireless portal server, comprising:
receiving service requests from said wireless clients connecting to the wireless portal server; and
parsing header information in said service requests to automatically extract client specific information and hierarchically comparing said client specific information to extensible predefined parameters stored in said wireless portal server in order to detect said wireless clients connecting to said wireless portal server.

23. The method of claim 22, further comprising hierarchically searching predefined client profile information to extract an exact match to said client specific information.

24. The method of claim 23, further comprising hierarchically searching said predefined client profile information to extract a partial match to said client specific information in said header information.

25. The method of claim 24, further comprising hierarchically searching said predefined client profile information to extract information common to a class of wireless devices supported by said wireless portal server that matches said client specific information in said header information.

26. The method of claim 25, wherein said header information comprises user-agent headers that are extracted from said service requests to detect wireless clients connecting to said wireless portal server.

27. The method of claim 26, wherein said header information further comprises composite capabilities preferences profile information.
